(19) United States
(12) Patent Application Publication
(10) Pub. No.: US 2022/0111920 A1
(43) Pub. Date: Apr. 14, 2022

(54) Adjustable Seat For Bicycle, Exercise Machine or the Like

(71) Applicant: Jian Xiang OUYANG, Temple City, CA (US)

(72) Inventor: Jian Xiang OUYANG, Temple City, CA (US)

(21) Appl. No.: 17/067,626

(22) Filed: Oct. 9, 2020

(51) Int. Cl. B62J 1/10; B62J 1/00

(52) U.S. Cl. CPC B62J 1/10; B62J 1/005

(57) ABSTRACT

An adjustable seat includes a seat frame and an adjustable assembly. The seat frame includes a first seat body and a second seat body spaced apart each other to define an adjustment channel between the first and second seat bodies. The adjustable assembly is supported underneath the seat frame for selectively adjusting a distance between the first and second seat bodies, wherein the adjustable assembly includes two adjustable members coupled at the first and second seat bodies respectively, and an adjustor rotatably coupled between the adjustable shafts. The adjustor is driven to rotate at a rotatable direction along a centerline of the adjustment channel to selectively adjust a width of the adjustment channel so as to selectively adjust the distance between the first and second seat bodies.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a bicycle frame, and more particularly to an adjustable seat for bicycle, exercise machine or the like, which is able to selectively adjust a dimensional size of the bicycle seat to fittingly support a user.

### Description of Related Arts

A bicycle saddle, also known as bicycle seat, is commonly attached to a seat post of a bicycle for enabling a rider to sit on the bicycle saddle. Generally speaking, there are two types of bicycle saddle, wherein one type is the performance saddle designed for road bikes and touring bikes, and another type is the cushioning saddle designed for recreational cycling and cruising. The bicycle saddle generally has a long narrow shape, wherein a rear portion of the bicycle saddle is enlarged to support the pelvis of the user so as to support the user's weight on the bicycle saddle when sitting on the bicycle saddle.

However, most of the users experience discomfort when sitting on the bicycle saddle, especially the performance saddle. Accordingly, when the user sits on the bicycle saddle, the body weight of the user will apply on a seat surface of the bicycle saddle. Due to the fixed contour of the seat surface of the bicycle saddle, different pressure points will be exerted to the user that causes the discomfort when sitting.

Some bicycle saddles are configured to alter the contour of the seat surface of the bicycle saddle for minimizing the pressure points to the user's body. Since the size of the bicycle saddle is universal, the bicycle saddle cannot fit different user's with different body sizes. Accordingly, a wider bicycle saddle is needed when the user has a wider pelvis in order to enhance the comfort level of the bicycle saddle when sitting thereon. However, most of the bicycle saddles cannot be adjusted their width. Therefore, there is a need for a bicycle saddle that can satisfy different user preferences with respect to the gender and body shape of the users.

### SUMMARY OF THE PRESENT INVENTION

The invention is advantageous in that it provides an adjustable seat for bicycle, exercise machine or the like, which is able to selectively adjust a dimensional size of the bicycle seat to fittingly support a user.

Another advantage of the invention is to provide an adjustable seat for bicycle, exercise machine or the like, wherein an overall width of the adjustable seat is selectively adjusted by adjusting a distance between two seat bodies via an adjustable assembly.

Another advantage of the invention is to provide an adjustable seat for bicycle, exercise machine or the like, wherein the distance between two seat bodies can be selectively adjusted via a rotation of an adjustor which is located between the seat bodies.

Another advantage of the invention is to provide an adjustable seat for bicycle, exercise machine or the like, wherein the user is able to simply rotate the adjustor at one direction to reduce the overall width of the adjustable seat and at an opposed direction to increase the overall width of the adjustable seat.

Another advantage of the invention is to provide an adjustable seat for bicycle, exercise machine or the like, wherein the adjustor is driven to rotate in a tool-less manner, such that the user is able to selectively adjust the overall width of the adjustable seat without requiring any tool.

Another advantage of the invention is to provide an adjustable seat for bicycle, exercise machine or the like, wherein the seat bodies are concurrently moved to adjust the distance therebetween to enhance an adjusting operation of the adjustable seat in a stable manner.

Another advantage of the invention is to provide an adjustable seat for bicycle, exercise machine or the like, wherein the adjustable assembly can be incorporated with any existing bicycle seat to selectively adjust the width thereof.

Another advantage of the invention is to provide an adjustable seat for bicycle, exercise machine or the like, which does not require to alter the original structural design of the bicycle seat, so as to minimize the manufacturing cost of the bicycle seat incorporating with the adjustable assembly.

Another advantage of the invention is to provide an adjustable seat for bicycle, exercise machine or the like, wherein no expensive or complicated structure is required to employ in the present invention in order to achieve the above mentioned objects. Therefore, the present invention successfully provides an economic and efficient solution for selectively adjusting the size of the bicycle seat and for enhancing a rigid configuration for the bicycle seat.

Additional advantages and features of the invention will become apparent from the description which follows, and may be realized by means of the instrumentalities and combinations particular point out in the appended claims.

According to the present invention, the foregoing and other objects and advantages are attained by an adjustable seat for bicycle, exercise machine or the like, comprising:

a seat frame comprising a first seat body and a second seat body spaced apart each other to define an adjustment channel between the first and second seat bodies; and

an adjustable assembly supported underneath the seat frame and configured to selectively adjust a distance between the first and second seat bodies.

The adjustable assembly comprises:

two adjustable members coupled at the first and second seat bodies respectively and aligned with each other; and

an adjustor rotatably coupled with the adjustable shafts, wherein the adjustor is driven to rotate at a rotatable direction along a centerline of the adjustment channel to selectively adjust a width of the adjustment channel so as to selectively adjust the distance between the first and second seat bodies.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an adjustable seat for a bicycle according to a preferred embodiment of the present invention.

FIG. 2 is a front view of the adjustable seat for the bicycle according to the above preferred embodiment of the present invention.

FIG. 3 is a side view of the adjustable seat for the bicycle according to the above preferred embodiment of the present invention.

FIG. 4 is an exploded perspective view of the adjustable seat for the bicycle according to the above preferred embodiment of the present invention.

FIG. 5 is a bottom view of the adjustable seat at a first position according to the above preferred embodiment of the present invention.

FIG. 6 is a bottom view of the adjustable seat at a second position according to the above preferred embodiment of the present invention.

FIG. 7 illustrates an adjustable assembly of the adjustable seat according to the above preferred embodiment of the present invention.

FIG. 8 illustrates an alternative mode of the adjustable assembly of the adjustable seat according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

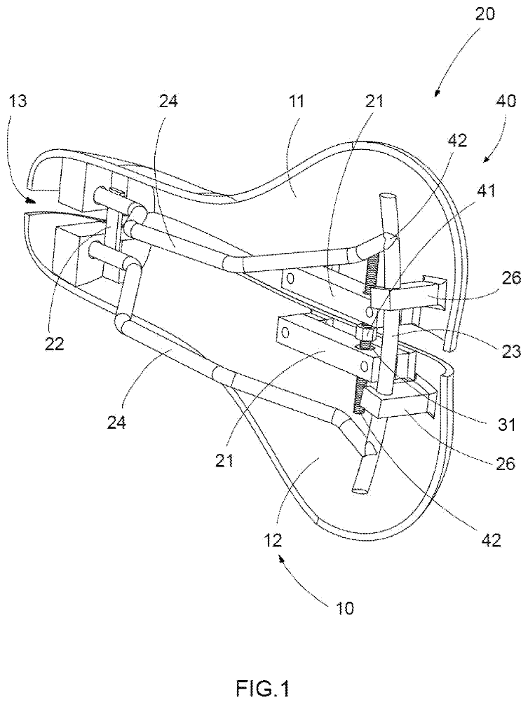

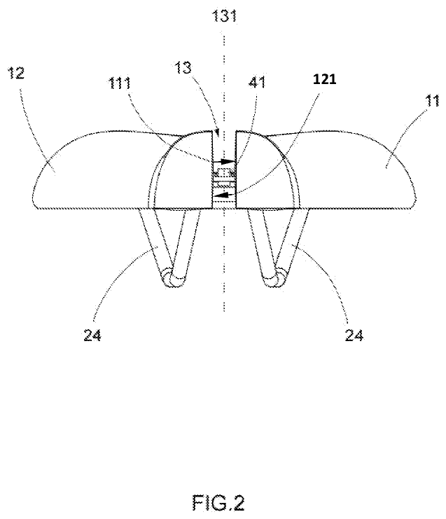

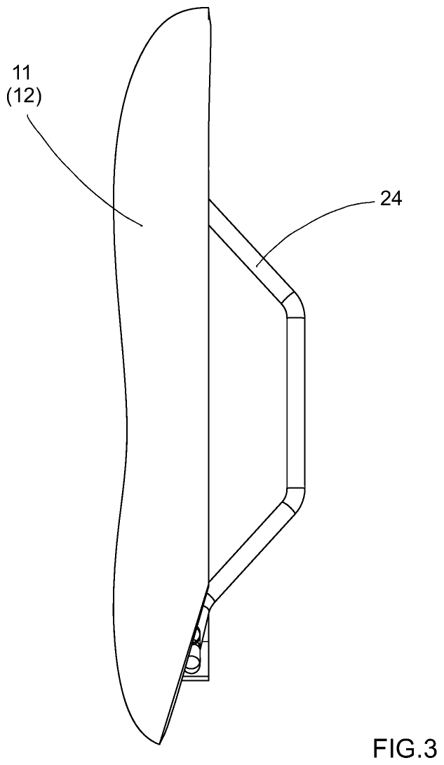

Referring to FIGS. 1 to 4 of the present invention, an adjustable seat for bicycle, exercise machine or the like according to the a preferred embodiment of the present invention is illustrated, wherein the adjustable seat is adapted for detachably coupling to the bicycle via a seat post assembly thereof. The adjustable seat of the present invention comprises a seat frame 10 for a user or a rider sitting thereon, and an adjustable assembly 20 supported underneath the seat frame 10.

The seat frame 10 comprises a first seat body 11 and a second seat body 12 spaced apart each other to define an adjustment channel 13 between the first and second seat bodies 11, 12. In the preferred embodiment, the first and second seat bodies 11, 12 are embodied as left and right seat bodies respectively, wherein the adjustment channel 13 forms a middle channel between the left and right seat bodies. It should be appreciated that the first and second seat bodies 11, 12 can be front and rear seat bodies or top and bottom seat bodies.

According to the preferred embodiment, the first and second seat bodies 11, 12 are identical and symmetrical along the adjustment channel 13, wherein each of the first and second seat bodies 11, 12 generally has a triangular shape. Each of the first and second seat bodies 11, 12 has a top cushioning surface and a bottom rigid surface. Each of the first and second seat bodies 11, 12 further has a straight inner edge 111, 112, wherein the adjustment channel 13 is formed between the straight inner edges 111, 112 of the first and second seat bodies 11, 12.

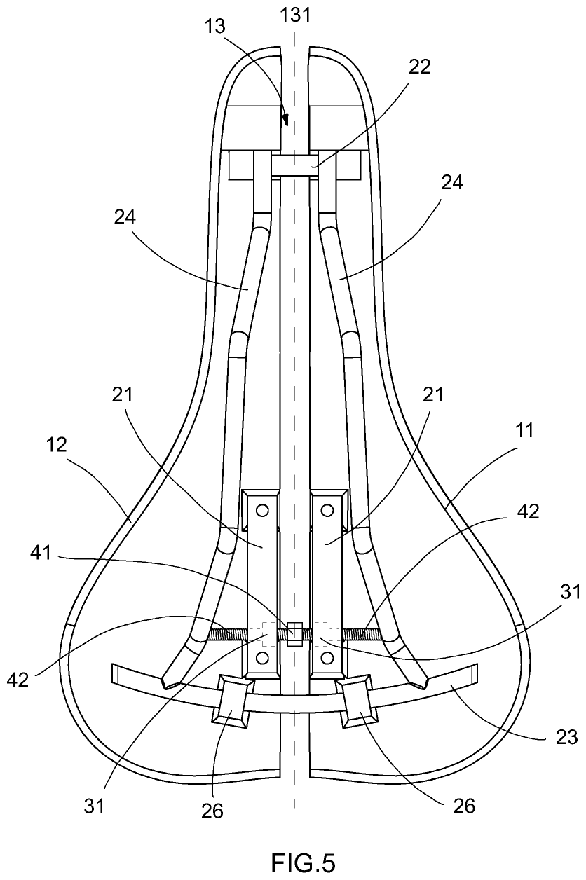

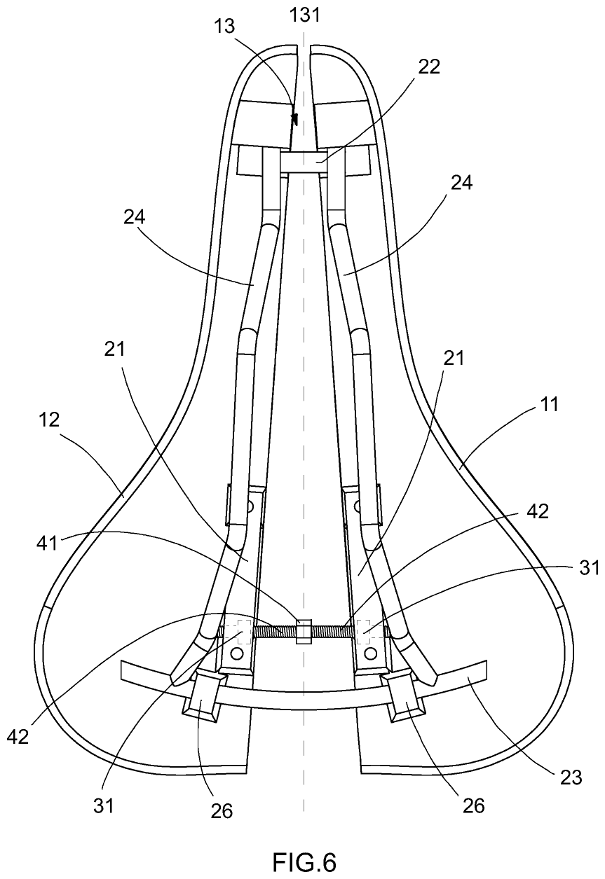

In the preferred embodiment, the adjustment channel 13 defines a centerline 131 which is also a centerline of the seat frame 10 between the first and second seat bodies 11, 12. A width of the adjustment channel 13 is selectively adjusted by the adjustable assembly 20 to selectively adjust a distance between the first and second seat bodies 11, 12 to selectively shift the seat frame 10 between a first position as shown in FIG. 5 and a second position as shown in FIG. 6. As shown in FIG. 5, when reducing the width of the adjustment channel 13, the distance between the first and second seat bodies 11, 12 is correspondingly decreased. Likewise, when increasing the width of the adjustment channel 13, the distance between the first and second seat bodies 11, 12 is correspondingly increased as shown in FIG. 6. In one embodiment, the first position of the seat frame 10 is an original seat position and the second position of the seat frame 10 is an extended seat position.

As shown in FIGS. 1 to 4, the adjustable assembly 20 is supported underneath the seat frame 10 and configured for selectively adjusting the distance between the first and second seat bodies 11, 12. The adjustable assembly 20 comprises two adjustable members 30 and an adjustor 40.

The adjustable members 30 are coupled at the first and second seat bodies 11, 12 respectively and aligned with each other. Preferably, the adjustable members 30 are coupled at the first and second seat bodies 11, 12 at rear-portions thereof respectively where the distance between the first and second seat bodies 11, 12 to be desirably adjusted.

The adjustor 40 is rotatably coupled with the adjustable members 30, preferably between the adjustable members 30, wherein the adjustor 40 is driven to rotate at a rotatable direction along the centerline 131 of the adjustment channel 13 to selectively adjust the width of the adjustment channel 13 so as to selectively adjust the distance between the first and second seat bodies 11, 12. Accordingly, the adjustor 40 has a disc portion that an axle of the adjustor 40 is perpendicular to the centerline 131 of the adjustment channel 13. It is worth mentioning that the axle of the adjustor 40 is defined as a rotatable axle of the disc portion of the adjustor 30, such that the disc portion of the adjustor 30 is rotatable along the centerline 131 of the adjustment channel 13. An uppermost point of the adjustor 40 is located below the top side of each of the first and second seat bodies 11, 12, such that any portion of the adjustor 40 will not protruded above the top side of each of the first and second seat bodies 11, 12 where the user sits thereon.

According to the preferred embodiment, when the adjustor 40 is rotated at one to direction to concurrently rotate the adjustable members 30, the distance between first and second seat bodies 11, 12 is reduced. When the adjustor 40 is rotated at an opposed direction to concurrently rotate the adjustable members 30, the distance between first and second seat bodies 11, 12 is increased.

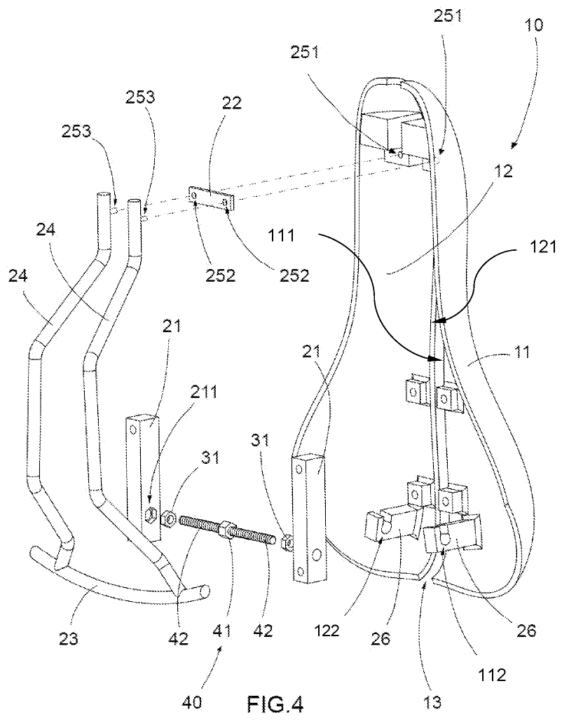

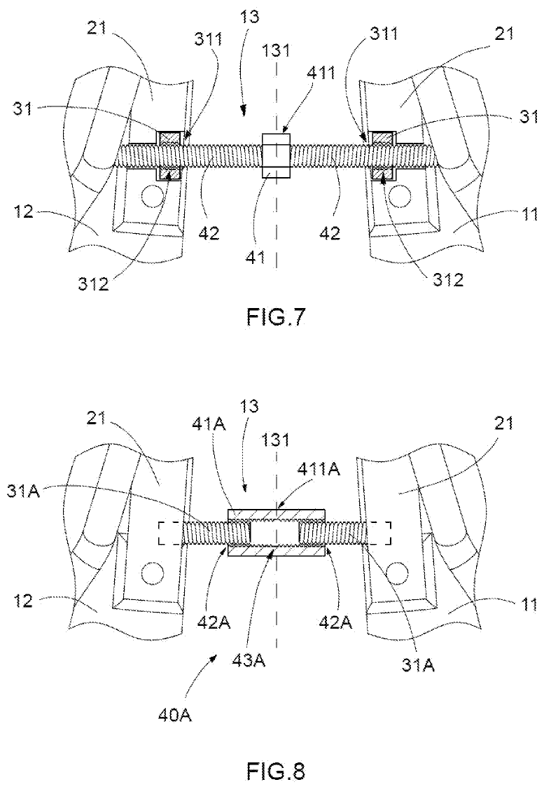

As shown in FIGS. 4 and 7, each of the adjustable members 30 comprises a threaded sleeve 31 having a side opening end 311 and a threaded inner wall 312, wherein the threaded sleeves 31 are coupled at the first and second seat bodies 11, 12 respectively, such that a distance between the threaded sleeves 31 is correspondingly adjusted in response to the width of the adjustment channel 13. Accordingly, the threaded sleeves 31 are aligned with each other at a position that the side opening ends 311 of the threaded sleeves 31 are coaxially aligned with each other. The threaded sleeves 31 are supported in a non-rotatable manner, such that the threaded sleeves 31 will not be driven to rotate when the adjustor 40 is rotated.

Correspondingly, the adjustor 40 comprises an adjusting wheel 41 and two threaded shafts 42 coaxially and opposedly extended from the adjusting wheel 41 to rotatably engage with the threaded inner walls 312 of the threaded sleeves 31 via the side opening ends 311 thereof. Therefore, when the adjusting wheel 41 is rotated, the threaded sleeves 31 are sidewardly moved in a synchronized manner to selectively adjust the width of the adjustment channel 13 so as to selectively adjust the distance between the first and second seat bodies 11, 12.

The adjusting wheel 41 is defined as the disc portion of the adjustor 40 to be driven to rotate. In one embodiment, the adjusting wheel 41 has a non-circular configuration and forms a polygonal configuration to have a plurality of user finger manipulating surfaces 411 being actuated to rotate the adjustor 40 in a tool-less manner. In other words, the user is able to rotate the adjusting wheel 41 by hand without any tool to adjust the distance between the first and second seat bodies 11, 12.

As shown in FIGS. 4 and 7, the threaded shafts 42 are coaxially extended from the adjusting wheel 41 and are perpendicular to the centerline 131 of the adjustment channel 13. Preferably, the threaded shafts 42 are integrally extended from the adjusting wheel 41 at the opposite directions, such that the threaded shafts 42 are coaxially aligned with each other. In other words, inner ends of the threaded shafts 42 are integrally extended from two sides of the adjusting wheel 41 respectively and outer ends of the threaded shafts 42 are extended to engage with the threaded inner walls 312 of the threaded sleeves via the side opening ends 311 thereof respectively. Therefore, when the adjusting wheel 41 is rotated, the threaded shafts 42 are driven to rotate correspondingly. Via the threaded engagement between the threaded shafts 42 and the threaded sleeves 31, the threaded shafts 42 are driven to rotatably slide in the threaded sleeves 31 respectively. When the outer ends of the threaded shafts 42 are slid toward the side opening ends 311 of the threaded sleeves 31, i.e. a direction toward the adjusting wheel 41, the distance between the threaded sleeves 31 is increased, such that the width of the adjustment channel 13 is correspondingly increased. Likewise, when the outer ends of the threaded shafts 42 are slid away from the side opening ends 311 of the threaded sleeves 31, i.e. a direction away from the adjusting wheel 41, a distance between the threaded sleeves 31 is reduced, such that the width of the adjustment channel 13 is correspondingly reduced.

In order to move the threaded sleeves 31 in a synchronized manner, threads of the threaded shafts 42 are extended in opposite spiral directions. Correspondingly, threads of the threaded inner walls 312 of the threaded sleeves 31 are extended in opposite spiral directions. Therefore, when the adjusting wheel 41 is rotated in one direction, the threaded sleeves 31 are concurrently moved toward the adjusting wheel 41 to reduce the distance between the first and second seat bodies 11, 12. When the adjusting wheel 41 is rotated at an opposed direction, the threaded sleeves 31 are concurrently moved away from the adjusting wheel 41 to increase the distance between the first and second seat bodies 11, 12.

As shown in FIGS. 4 to 7, the adjustable assembly 20 further comprises two retention members 21 affixed to the first and second seat bodies 11, 12 respectively. Accordingly, each of the retention members 21 has an elongated block configuration, wherein the retention members 21 are affixed at the bottom rigid surfaces of the first and second seat bodies 11, 12 respectively. Accordingly, the threaded sleeves 31 are embedded in the retention members 21 respectively to prevent rotatable movements thereof when the adjusting wheel 41 is rotated. Each of the retention members 21 has a retention slot 211 formed at an inner surface thereof, wherein the threaded sleeve 31 is received in the retention slot 211 of the retention member 21. Each of the threaded sleeve 31 has a non-circular shape and the retention slot has the corresponding non-circular configuration, such that when the threaded sleeve 31 is received in the retention slot of the retention member 21, the threaded sleeve 31 cannot not rotate when the adjustor 40 is driven to rotate. Each of the retention members 21 further has a through hole formed at an outer surface thereof to communicate with the retention slot 211, wherein the outer ends of the threaded shafts 42 can slidably extend through the through hole when the threaded shafts 42 are rotatably slid through the threaded sleeves 31.

FIG. 8 illustrates an alternative mode of the adjustable members 30A and the adjustor 40A. Accordingly, each of the adjustable members 30A comprises a threaded shaft 31A, wherein the threaded shafts 31A are extended from the first and second bodies 11, 12 to the adjustment channel 13 and are aligned with each other end-to-end. Particularly, the threaded shafts 31A are affixed to the retention members 21 respectively, such that the threaded shafts 31A are supported in a non-rotatable manner. Therefore, outer ends of the threaded shafts 31A are embedded in the retention members 21 respectively and inner ends of the threaded shafts 31A are extended to the adjustment channel 13.

The adjustor 40A comprises a tubular adjusting wheel 41A having two side opening ends 42A and a threaded inner wall 43A, wherein the adjusting wheel 41A is defined as the disc portion of the adjustor 40A. The adjusting wheel 41A is supported within the adjustment channel 13 and is perpendicular to the centerline 131 of the adjustment channel 13. The adjusting wheel 41A has a non-circular configuration and forms a polygonal configuration to have a plurality of user finger manipulating surfaces 411A being actuated to rotate the adjustor 40A in a tool-less manner.

The threaded shafts 31A are engaged with the threaded inner walls 43A of the adjusting wheel 41A via the side opening ends 42A thereof, such that when the adjusting wheel 41A is rotated, the threaded shafts 31A are sidewardly moved in a synchronized manner to selectively adjust the width of the adjustment channel 13 so as to selectively adjust the distance between the first and second seat bodies 11, 12. In other words, when the adjusting wheel 41A is rotated at one direction, the outer ends of the threaded shaft 31A are slid within the adjusting wheel 41 and are slid toward each other so as to reduce the width of the adjustment channel 13. When the adjusting wheel 41A is rotated at an opposed direction, the outer ends of the threaded shaft 31A are slid within the adjusting wheel 41 and are slid away from each other so as to increase the width of the adjustment channel 13.

In order to move the threaded shafts 31A in a synchronized manner, the adjusting wheel 41A has two threads formed at the threaded inner wall 43A. The threads of the threaded inner wall 43A of the adjusting wheel 41A are extended from the two side opening ends 42A in opposite spiral directions. Correspondingly, threads of the thread shafts 31A are extended in opposite spiral directions. Therefore, when the adjusting wheel 41A is rotated at one direction, the threaded shafts 31A are concurrently moved toward the adjusting wheel 41A to reduce the distance between the first and second seat bodies 11, 12. When the adjusting wheel 41A is rotated at an opposed direction, the threaded shafts 31A are concurrently moved away from the adjusting wheel 41A to increase the distance between the first and second seat bodies 11, 12. In other words, when the adjusting wheel 41A is rotated at one direction, the threaded shafts 31A are concurrently slid within the adjusting wheel 41A at a position that the outer ends of the threaded shafts 31A are moved away from each other to increase the distance between the first and second seat bodies 11, 12. When the adjusting wheel 41A is rotated at the opposed direction, the threaded shafts 31A are concurrently slid within the adjusting wheel 41A at a position that the outer ends of the threaded shafts 31A are moved toward each other to reduce the distance between the first and second seat bodies 11, 12.

As shown in FIGS. 1 and 4 to 6, the adjustable assembly 20 further comprises a control arm 22 and a guiding arm 23 spaced apart from each other and coupled between the first and second seat bodies 11, 12 to across the adjustment channel 13. Accordingly, the control arm 22 is affixed between the first and second seat bodies 11, 12 to retain the width of the adjustment channel 13. The guiding arm 23 is slidably coupled between the first and second seat bodies 11, 12 to selectively adjust the width of the adjustment channel 13. In other words, when the adjustor 40 is rotated, the control arm 22 retains the width of the adjustment channel 13 while the guiding arm 23 is slid between the first and second seat bodies 11, 12 to adjust the width of the adjustment channel 13.

According to the preferred embodiment, the control arm 22 and the guiding arm 23 are coupled at front portions and rear portions of the first and second seat bodies 11, 12, wherein the adjustor 40 is located between the control arm 22 and the guiding arm 23 to ensure the distance between the first and second seat bodies 11, 12 being adjusted stably. When the adjustor 40 is rotated, the width of the adjustment channel 13 at the front portions of first and second seat bodies 11, 12 is remained unchanged via the control arm 22. At the same time, the width of the adjustment channel 13 at the rear portions of first and second seat bodies 11, 12 is selectively adjusted and is guided via the sliding movement of the guiding arm 23. Furthermore, a length of the control arm 22 is shorter than a length of the guiding arm 23, such that the width of the adjustment channel 13 at the rear portions of first and second seat bodies 11, 12 can be maximized via the length of the guiding arm 23. Since the width of the adjustment channel 13 at the front portions of first and second seat bodies 11, 12 is fixed, the control arm 22 has an elongated straight configuration, wherein two ends of the control arm 22 are affixed to the first and second seat bodies 11, 12 respectively. For guiding the width adjustment of the adjustment channel 13 at the rear portions of first and second seat bodies 11, 12, the guiding arm 23 has an elongated curved configuration, such that the rear portions of first and second seat bodies 11, 12 are guided to move along a curvature of the guiding arm 23.

Accordingly, each of the first and second seat bodies 11, 12 has a sliding slot 112, 122 slidably engaging with two end portions the guiding arms 23 respectively. As shown in FIG. 4, each of the first and second seat bodies 11, 12 comprises an extension member 26 downwardly extended from the bottom rigid surface thereof, wherein the sliding slots 112, 122 are formed at the extension members 26 of the first and second seat bodies 11, 12 respectively.

The adjustable assembly 20 further comprises two retention arms 24 supported underneath the first and second seat bodies 11, 12 respectively, wherein the control arm 22 and the guiding arm 23 are coupled to the retention arms 24 to enhance a rigid configuration of each of the first and second seat bodies 11, 12.

As shown in FIGS. 4 to 6, each of the retention arms 24 has a first end and an opposed second end, wherein the first and second ends of the retention arm 24 are shown as front and rear ends thereof. The two first ends, i.e. the front ends, of the retention arms 24 are pivotally coupled at two ends of the control arm 22 and are pivotally coupled to the first and second seat bodies 11, 12 via a pivot joint respectively. As shown in FIG. 4, the pivot joint comprises a pivot slot 251 formed at each of the first and second seat bodies 11, 12, a through slot 252 formed at each end of the control arm 22, and a pivot shaft 253 protruded from the front end of each of the retention arms 24. The pivot shaft 253 is extended through the through slot 252 and is pivotally engaged with the pivot slot 251 so as to pivotally couple the front ends of the retention arms 24 with the first and second seat bodies 11, 12 via the control arm 22.

The two second ends, i.e. the rear ends, of the retention arms 24 are affixed to two end portions of guiding arms 23, wherein the sliding slots 112, 122 are located between the two rear ends of the retention arms 24 to enhance the sliding stabilization of the first and second seat bodies 11, 12 along the guiding arm 23.

In order to selective adjust the overall width of the seat frame 10, the user is able to actuate the adjustor 40 in order to rotate the adjustor 40 for selectively adjusting the distance between the first and second seat bodies 11, 12. At the first position of the seat frame 10, i.e. the original position of the seat frame 10, as shown in FIG. 5, the width of the adjustment channel 13 is uniform, such that the distance between the front portions of the first and second seat bodies 11, 12 is the same as the distance between the rear portions of the first and second seat bodies 11, 12. When the adjusting wheel 41 is rotated at one direction to drive the threaded sleeves 31 rotatably sliding toward each other along the threaded shafts 42, the first and second seat bodies 11, 12 are moved to its first position, i.e. the original position, as shown in FIG. 5. At the first position of the seat frame 10, the width of the adjustment channel 13 is uniform. When the adjusting wheel 41 is rotated at the opposite direction to drive the threaded sleeves 31 rotatably sliding away from each other along the threaded shafts 42, the first and second seat bodies 11, 12 are moved to its second position, i.e. the extended position, as shown in FIG. 6. At the second position of the seat frame 10, the width of the adjustment channel 13 is gradually increased from front to rear. In other words, the distance between the front portions of the first and second seat bodies 11, 12 is shorter than the distance between the rear portions of the first and second seat bodies 11, 12.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. An adjustable seat, comprising:
a seat frame comprising a first seat body and a second seat body spaced apart each other to define an adjustment channel between said first and second seat bodies; and
an adjustable assembly supported underneath said seat frame and configured to selectively adjust a distance between said first and second seat bodies, wherein said adjustable assembly comprises:
a first retention arm and a second retention arm supported underneath said first seat body and said second seat body respectively;
a first extension member and a second extension member provided at a first rear portion of said first seat body and a second rear portion of said second seat body respectively, wherein said first extension member has a first sliding slot and said second extension member has a second sliding slot;
a guiding arm, having an elongated curved configuration, slidably coupled at said first extension member of said first seat body and said second extension member of said second seat body and extended across said adjustment channel through slidably coupling a first end portion of said guiding arm with said first sliding slot of said first extension member and slidably coupling a second end portion of said guiding arm with said second sliding slot of said second extension member, such that said rear portions of said first seat body and said second seat body are guided to move along a curvature of said guiding arm to allow a width of said adjustment channel between said first seat body and said second seat body being selectively adjusted;
a first adjustable member coupled at said first seat body and a second adjustable member coupled at said second seat body and aligned with each other; and
an adjustor rotatably coupled with said adjustable members, wherein said adjustor is configured to be driven to rotate along a centerline of said adjustment channel to selectively adjust a width of said adjustment channel so as to selectively adjust said distance between said first and second seat bodies, such that when said adjustor is rotated, said control arm retains said width of said adjustment channel while said guiding arm is slid between said first sliding slot of said first extension member and said second sliding slot of said second extension member to adjust said width of said adjustment channel.

2. The adjustable seat, as recited in claim 1, wherein a first rear end of said first retention arm and a second rear end of said second retention arm are affixed to two end portions of said guiding arm.

3. The adjustable seat, as recited in claim 1, wherein when said adjustor is rotated at one direction to concurrently rotate said adjustable members, said distance between first and second seat bodies is reduced, and when said adjustor is rotated at an opposed direction to concurrently rotate said adjustable members, said distance between first and second seat bodies is increased.

4. The adjustable seat, as recited in claim 1, wherein at least one of each of said first and second adjustable members comprises a threaded sleeve, having a side opening end and a threaded inner wall, coupled at one of said first and second seat bodies, wherein said adjustor comprises an adjusting wheel and at least a threaded shaft coaxially and opposedly extended from said adjusting wheel to rotatably engage with said threaded inner wall of said threaded sleeve via said side opening end thereof, such that when said adjusting wheel is rotated, said threaded sleeve is sidewardly moved to selectively adjust said width of said adjustment channel so as to selectively adjust said distance between said first seat body and said second seat body.

5. The adjustable seat, as recited in claim 1, wherein each of said first and second adjustable members comprises a threaded sleeve, having a side opening end and a threaded inner wall, wherein said threaded sleeves of said first and second adjustable members are coupled at said first and second seat bodies respectively, wherein said adjustor comprises an adjusting wheel and two threaded shafts coaxially and opposedly extended from said adjusting wheel to rotatably engage with said threaded inner walls of said threaded sleeves via said side opening ends thereof respectively, such that when said adjusting wheel is rotated, said threaded sleeves are sidewardly moved in a synchronized manner to selectively adjust said width of said adjustment channel so as to selectively adjust said distance between said first and second seat bodies, wherein each of said threads of said thread shafts are extended in opposite spiral directions, such that when said adjusting wheel is rotated in one direction, said threaded sleeves are concurrently moved toward said adjusting wheel to reduce said distance between said first and second seat bodies, and when said adjusting wheel is rotated at an opposed direction, said threaded sleeves are concurrently moved away from said adjusting wheel to increase said distance between said first and second seat bodies.

6. The adjustable seat, as recited in claim 5, wherein said threaded shafts are integrally extended from said adjusting wheel and are perpendicular to said centerline of said adjustment channel.

7. The adjustable seat, as recited in claim 5, wherein said adjustable assembly further comprises two retention members affixed to said first and second seat bodies respectively, wherein said threaded sleeves are embedded in said retention members respectively to prevent rotatable movements thereof when said adjusting wheel is rotated.

8. The adjustable seat, as recited in claim 1, wherein each of said adjustable members comprises a threaded shaft extended from one of said first and second bodies to said adjustment channel, wherein said adjustor comprises a tubular adjusting wheel having two side opening ends and a threaded inner wall, wherein said threaded shafts are engaged with said threaded inner walls of said adjusting wheel via said side opening ends thereof, such that when said adjusting wheel is rotated, said threaded shafts are sidewardly moved in a synchronized manner to selectively adjust said width of said adjustment channel so as to selectively adjust said distance between said first and second seat bodies.

9. The adjustable seat, as recited in claim 8, wherein threads of said threaded inner wall of said adjusting wheel are extended from said two side opening ends in opposite spiral directions, such that when said adjusting wheel is rotated in one direction, said threaded shafts are concurrently moved toward said adjusting wheel to reduce said distance between said first and second seat bodies, and when said adjusting wheel is rotated at an opposed direction, said threaded shafts are concurrently moved away from said adjusting wheel to increase said distance between the first and second seat bodies.

10. The adjustable seat, as recited in claim 8, wherein said adjusting wheel is supported within said adjustment channel and is perpendicular to said centerline of said adjustment channel.

11. The adjustable seat, as recited in claim 8, wherein said adjustable assembly further comprises two retention members affixed to said first and second seat bodies respectively, wherein said threaded shafts are non-rotatably extended from said retention members respectively to engage with said adjusting wheel.

12. The adjustable seat, as recited in claim 1, wherein said adjustable assembly further comprises a control arm coupled between said first and second seat bodies to across said adjustment channel, such that when said adjustor is rotated, said control arm retains said width of said adjustment channel while said guiding arm is slid between said first and second seat bodies to adjust said width of said adjustment channel.

13. The adjustable seat, as recited in claim 12, wherein said first and second sliding slots are slidably engaging with two end portions said guiding arm respectively.

14. The adjustable seat, as recited in claim 12, wherein said control arm has an elongated straight configuration, wherein said adjustor is located between said control arm and said guiding arm to ensure said distance between said first and second seat bodies being adjusted stably.

15. The adjustable seat, as recited in claim 12, wherein a length of said control arm is shorter than a length of said guiding arm.

16. The adjustable seat, as recited in claim 12, wherein said control arm and said guiding arm are coupled to said first and second retention arms to enhance a rigid configuration of each of said first and second seat bodies.

17. The adjustable seat, as recited in claim 16, wherein each of said retention arms has a first end pivotally coupled to one of said first and second seat bodies at said control arm and a second end affixed to said guiding arm.

18. The adjustable seat, as recited in claim 1, wherein an uppermost point of said adjustor is located below a top side of each of said first and second seat bodies.

19. The adjustable seat, as recited in claim 1, wherein said first and second seat bodies are left and right seat bodies, such that said distance between said first and second seat bodies are selectively adjusted to alter an overall width of said adjustable seat.

20. The adjustable seat, as recited in claim 1, wherein said adjustor is a manual turning wheel having a plurality of user finger manipulating surfaces being actuated to rotate said adjustor in a tool-less manner.
